(19) United States
(12) Patent Application Publication
(10) Pub. No.: US 2018/0092336 A1
(43) Pub. Date: Apr. 5, 2018

(54) AUTONOMOUS MOBILE BEEHIVES

(71) Applicant: International Business Machines Corporation, Armonk, NY (US)

(72) Inventors: Thomas D. Erickson, Minneapolis, MN (US); Kala Fleming, Nairobi (KE); Clifford A. Pickover, Westchester, NY (US); Maja Vukovic, New York, NY (US); Komminist Weldemariam, Nairobi (KE)

(21) Appl. No.: 15/285,189

(22) Filed: Oct. 4, 2016

(51) Int. Cl. A01K 49/00; A01K 47/06; G05D 1/00

(52) U.S. Cl. CPC A01K 49/00; G05D 1/0088; A01K 47/06

(57) ABSTRACT

A system for moving a beehive. The system includes a hive enclosure for housing a bee colony with a hive entrance to the hive enclosure. An insect detector is configured to identify undesirable insects attempting to access the hive enclosure. A door is configured to exclude the undesirable insects detected by the insect detector from passing through the hive entrance. An autonomous vehicle is coupled to the hive enclosure and is configured to automatically move the hive enclosure from a first location to a second location.

### BACKGROUND

The present invention is directed toward bee keeping, and more particularly to system for moving beehives.

Bees gather their nutrition by collecting pollen and nectar from flowers. In a natural ecosystem, different plants flower at different times during the season, enabling the colony to gather consistent nourishment. In an ecosystem that has been degraded so that it does not have a full range of flowering plants, or in an agricultural monoculture, bee colonies may have difficulty getting nutrition during part of the season, and may be damaged or killed. As a consequence, commercial providers deliver bee colonies to crops that are in bloom and follow blooms around the country. Thus, agriculture is increasingly dependent on commercial services that provide managed hives on demand.

Pollinators are in decline due to a range of stresses that include natural antagonists (e.g., mites, ants, and diseases), artificial antagonists (e.g., pesticides), and habitat destruction and monoculture cultivation (i.e., bees have difficulty maintaining an adequate diet when the primary cultivar is not blooming). The same problems that afflict wild pollinators also afflict managed ones.

In addition, the introduction and hybridization of African honeybees with European bees also poses problems. Hybrids of African and European honeybees, referred to as “Africanized Honeybees” are spreading in North America and are generally more aggressive, more likely to abandon hives, and do not fare well in cold winter areas. These traits can pose problems for commercial pollination services.

### BRIEF SUMMARY

Accordingly, aspects of the present invention may include a mobile beehive container, a means for containing a beehive in an autonomous aircraft drone or a self-driving car, a means for estimating the kinds of insects entering the container and excluding undesirable insects, and a means for automatically moving the aircraft drone or self-driving car containing the hive to another location.

One example aspect of the present invention is a system for moving a beehive. The system includes a hive enclosure for housing a bee colony with a hive entrance to the hive enclosure. An insect detector is configured to identify undesirable insects attempting to access the hive enclosure. A door is configured to exclude the undesirable insects detected by the insect detector from passing through the hive entrance. An autonomous vehicle is coupled to the hive enclosure and is configured to automatically move the hive enclosure from a first location to a second location.

Another example aspect of the present invention is a method for moving a beehive. The method includes identifying undesirable insects attempting to access a hive enclosure by an insect detector. An excluding step excludes the undesirable insects detected by the insect detector from passing through a hive entrance to the hive enclosure. A moving step automatically moves the hive enclosure from a first location to a second location by an autonomous vehicle coupled to the hive enclosure.

Yet a further example aspect of the present invention is a computer program product for moving a beehive. The computer program product includes computer readable program code configured to: identify undesirable insects attempting to access a hive enclosure by an insect detector; exclude the undesirable insects detected by the insect detector from passing through a hive entrance to the hive enclosure; and automatically move the hive enclosure from a first location to a second location by an autonomous vehicle coupled to the hive enclosure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example system for moving a beehive contemplated by the present invention.

FIG. 2 shows an example method for moving a beehive, as contemplated by the present invention.

FIG. 3 shows an example pattern training and recognition processes that may be utilized by the present invention.

### DETAILED DESCRIPTION

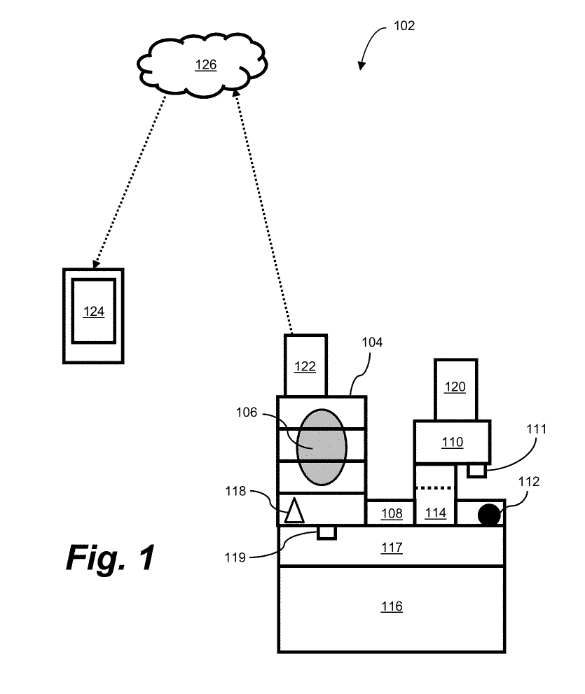

The present invention is described with reference to embodiments of the invention. Throughout the description of the invention reference is made to FIGS. 1-3. When referring to the figures, like structures and elements shown throughout are indicated with like reference numerals.

Aspects of the present invention include a method and system comprising a mobile container, such as a flying drone, a self-driving car (SDC), or both working in concert, a means for containing a beehive in the drone or SDC (and/or attracting bees to the drone or SDC), a means for estimating the kinds of insects entering the container and excluding undesirable insects, and a means for automatically moving the hive that formed in drone or SDC containing the hive to another location (e.g., to an apiary or a field with crops that require pollinators). In some embodiments, the mobile system functions as a bait hive.

FIG. 1 shows an example system 102 for moving a beehive contemplated by the present invention. The system 102 includes a hive enclosure 104 for housing a bee colony 106. The hive enclosure 104 includes a hive entrance 108 to the hive enclosure 104.

An insect detector 110 is configured to identify undesirable insects 112 attempting to access the hive enclosure 104. In one embodiment, the insect detector 110 uses artificial neural networks (ANNs) and a support vector machine (SVM) to identify the undesirable insects. The insect detector 110 may use time of year and weather conditions to identify the undesirable insects. In one embodiment, a high-definition camera 111, an image processor, and a main controller may be employed for insect analysis, hive analysis, etc. The image processor may be connected with the high-definition camera 111 and used for performing picture processing on the potential insect, hive, and/or swarming pictures to obtain insect types.

The system 102 includes a door 114 configured to exclude the undesirable insects 112 detected by the insect detector 110 from passing through the hive entrance 108. The system 102 may also include a bee attractant 118 for attracting bees into the hive enclosure 104.

In one embodiment, a synthetic resinous material which is acceptable to the bees, which is not attacked by vermin, and which exhibits the requisite physical properties to provide a desirable beehive, may be placed inside the hive enclosure 104. Molded urethane foam panels may be used, with the urethane foam being formulated so as to produce a product which is not rejected by the bees and which does not make the bees nervous or otherwise interfere with their normal habits in secreting honey in the hive enclosure 104.

The system 102 further includes an autonomous vehicle 116 coupled to the hive enclosure 104. The autonomous vehicle 116 is configured to automatically move the hive enclosure 104 from a first location to a second location. As used herein, an autonomous vehicle is a motor vehicle that uses artificial intelligence, sensors and global positioning system coordinates to drive itself without the active intervention of a human operator. In one embodiment, the autonomous vehicle 116 is an unmanned aerial vehicle, also known as a flying drone. In another embodiment, the autonomous vehicle 116 is a self-driving car. The autonomous vehicle 116 can be configured to automatically move the hive enclosure 104 from the first location to the second location when a frequency of the undesirable insects 112 detected by the insect detector 110 is greater than an insect threshold level.

At moving step 212, the hive enclosure is automatically moved from the first location to a second location by an autonomous vehicle coupled to the hive enclosure. In one embodiment, the hive enclosure is automatically moved from the first location to the second location when the pesticide concentration level is greater than a pesticide threshold level. Alternatively, or additionally, the hive enclosure is automatically moved from the first location to the second location when a frequency of the undesirable insects detected by the insect detector is greater than an insect threshold level.

The hive enclosure 104 may be automatically moved to habitats where there is plentiful food, or that has other desirable characteristics. The hive enclosure 104 can be moved as part of a commercial pollination service. For example, the hive enclosure 104 can be moved around a large field as flowers in one area of the field are pollinated. Similarly, the hive enclosure 104 can be moved to other regions via a self-driving car or an aircraft drone based on data that enables the flowering time of various plants to be forecast.

The hive enclosure 104 may be automatically triggered to move at a convenient time, such as at night when it is cool and bees are calm. The selection of a useful time can be improved using weather dependent population models. For example, wax moths are more active during the evenings when temps are cooler.

Relocation of the hive enclosure 104 may be optimized in terms of providing a water supply (or being near water), supply heat, supplying a windbreak, locating close to an apiary so that they can be observe regularly, locating them near clean areas of nectar.

In some embodiments, the hive enclosure 104 includes an interface 117 for pickup by the autonomous vehicle 116. In such embodiments, the hive enclosure 104 may include sensors 119 to help the autonomous vehicle 116 align with and engage the interface 117.

In one embodiment, system 102 includes a pesticide detector 120 configured to detect a pesticide concentration level at the first location. Furthermore, the autonomous vehicle 116 may be configured to automatically move the hive enclosure 104 from the first location to the second location when the pesticide concentration level is greater than a pesticide threshold level.

In one embodiment, system 102 includes a transmitter 122 to transmit to a beekeeper computer 124 hive metrics via a computer network 126. The hive metrics may include a geographical location of the hive enclosure 104, weather conditions at the hive enclosure 104, a frequency of the undesirable insects detected by the insect detector 110, and a honey production rate at the hive enclosure 104.

Within the hive enclosure 104, sensors can help determine if the hive is getting overcrowded, whether the queen is laying, and even whether the hive has been stolen. The system 102 can relay information to a beekeeper's smartphone regarding honey production, weather conditions, and even external threats. The hive enclosure 104 may include a weighing scale, a temperature probe, a hive monitor, an entry gate that counts bees as they come and go, and a central communications hub.

In some embodiments, the system 102 monitors the “healthiness” of the bees and determines the quality or productivity of the bees using predictive analytics and based on similar patterns in the past. Monitored information from the system 102 is accessible from a dashboard using a custom software utility. Investors or farm aggregators can access this information in one or more devices or application interfacing with the software utility. The embodiments of the present invention may provide farmer credit or market access based on the monitored information.

The system 102 may include a beehive heater for installation between the lower brood chamber and the bottom board of a beehive to protect a colony during the winter with a minimum of winter brood production and to accelerate spring brood production. The temperature of the air may be thermostatically controlled with the control point adjustable so that it may be set for winter or spring operation.

The system 102 may include a dehumidifier for collecting and disposing of unwanted moisture within the hive enclosure 104 during periods of temperature and humidity conditions that promote alternate freezing and thawing. The hive enclosure 104 can be arranged to direct and channel collected water from the condensation surface and discharge the same outside of the hive.

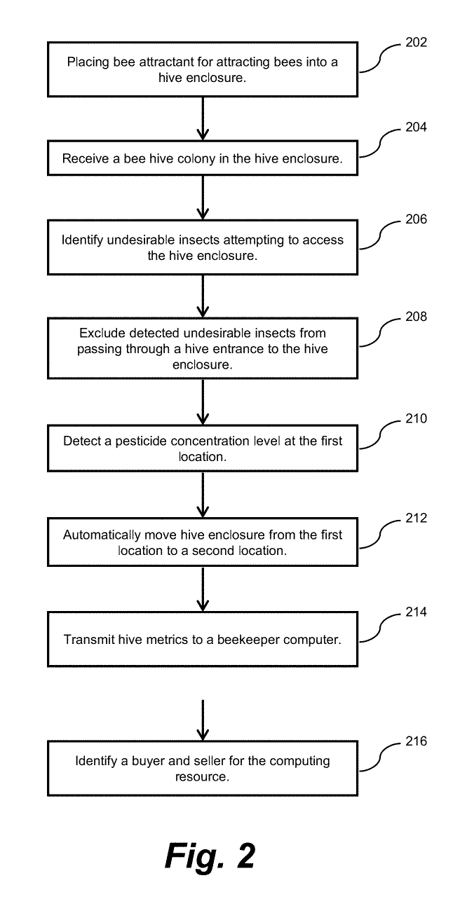

FIG. 2 shows an example method for moving a beehive, as contemplated by the present invention. The method includes placing step 202. During placing step 202, a bee attractant for attracting bees is placed into a hive enclosure. To attract bees, the hive enclosure can be propolized on its inside. Propolis is a red or brown resinous substance collected by honeybees from tree buds, used by them to fill crevices and to seal and varnish honeycombs. Alternatively, lemon grass oil may be used as an attractant.

In some embodiments, an attractant is used to attract pests. As just one example, the composition may include a volatile insect attractant chemical blend comprising acetic acid and one or more compounds selected from the short chain alcohol group chosen from among methyl-1-butanol, isobutanol, and 2-methyl-2-propanol; and one or more homo- or mono-terpene herbivore-induced plant volatiles chosen from among (E)-4,8-dimethyl-1,3,7-nonatriene, (Z)-4,8-dimethyl-1,3,7-nonatriene, 4,8, 12-trimethyl-1, 3E, 7E, 11-tridecatetraene, trans-β-ocimene, ds-P-ocimene, iraws-a-ocimene, ds-a-ocimene, and any combination thereof. The composition may be useful to attract one or more insect species. After placing step 202 is completed, the method proceeds to receiving step 204.

At receiving step 204, a beehive colony is received in the hive enclosure. Receiving step 204 may be achieved by either a bee swarm naturally selecting the hive enclosure as its new home, or by placing a beehive into the hive enclosure. After receiving step 204, the method proceeds to identifying step 206.

At identifying step 204, undesirable insects attempting to access the hive enclosure are identified by an insect detector. Insect identification can be performed by one or more means. For example, insects may be identified by digital image progressing, pattern recognition and the theory of taxonomy. Artificial neural networks (ANNs) and a support vector machine (SVM) can be used as pattern recognition methods for the identifications. (See Jiangning Wanga, et al., “A new automatic identification system of insect images at the order level”, www.sciencedirect.com/science/article/pii/S0950705112000822, incorporated herein by reference in its entirety.) Other input parameters may be considered such as body shape and pattern characteristics, body eccentricity, color complexity, center of gravity of insect silhouette, etc. Also, for some insect groups, wing outline is an important character for species identification. Thus, the method and system may employ a program as part of an automated system to identify insects based on wing outlines. This program includes two main functions: (1) outline digitization and Elliptic Fourier transformation and (2) classifier model training by pattern recognition of support vector machines and model validation. (See He-Ping Yang, “Tool for developing an automatic insect identification system based on wing outlines”, www.ncbi.nlm.nih.gov/pmc/articles/PMC4528224/, incorporated herein by reference in its entirety.) The method may also take into account time of year and weather to narrow the options for candidate insects to supplement the ANNs and SVM and increase the confidence level in pattern recognition and identifications.

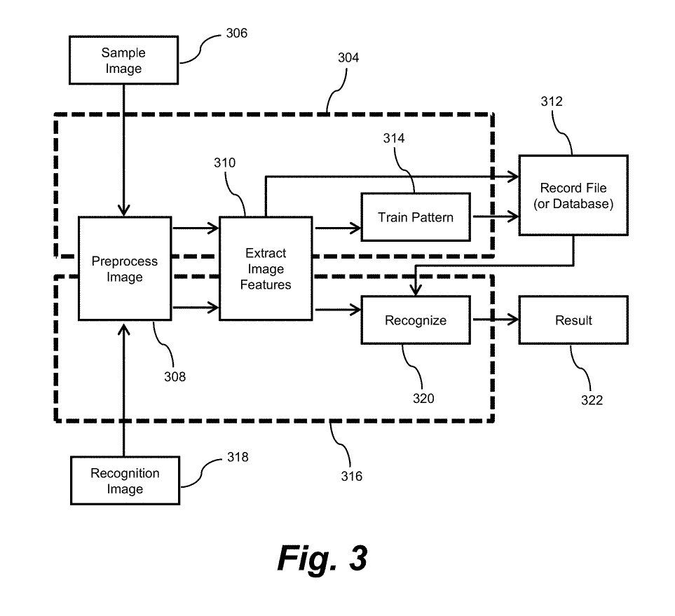

FIG. 3 shows an example pattern training and recognition processes 302 that may be utilized by the present invention. During the pattern training process 304, sample images 306 are input into a preprocessor 308. The preprocessor 306 may perform various image corrections and enhancements to the sample images. Image features from the sample images 306 are then extracted by an image feature extractor 310. The image features are recorded in a database 312. A pattern trainer 314 is used to determine patterns in the image features. The patterns are also recorded in the database 312.

During the recognition process 304, an input image 318 to be recognized is input to the preprocessor 308. Next, image features from the input image 318 are extracted by the image feature extractor 310. The image features are provided to a recognition engine 314. The recognition engine 314 matches the image features from the input image 318 to the image features stored in the database 312. A result 322 informs if the input image 318 matches the sample images 306.

Bees may be monitored for the presence of disease, such as foulbrood, or Varroa mites. Other insects, such as ants or parasitic bees, may be monitored. Drone bees and bees that have disease could be characterized as undesirable insects. Antagonistic insects could also be characterized as undesirable insects. The estimation of the kinds of insects may further include monitoring the hive and killing those insects showing symptoms of the disease using a genetic algorithm by speeding up a natural selection process.

Returning to FIG. 2, at excluding step 208, the undesirable insects detected by the insect detector are excluded from passing through a hive entrance to the hive enclosure. An opening and closing door may be used to prevent entry by undesirable insects, triggered by insect identification. An air pump may also be used to blow puffs of air at undesirable insects.

At detecting step 210, a pesticide concentration level is detected at the first location. For example, the pesticide detector may be configured to detect the presence of imidacloprid and other neonicotinoids. After detecting step 210, the method proceeds to moving step 212.

At moving step 212, the hive enclosure is automatically moved from the first location to a second location by an autonomous vehicle coupled to the hive enclosure. In one embodiment, the hive enclosure is automatically moved from the first location to the second location when the pesticide concentration level is greater than a pesticide threshold level. Alternatively, or additionally, the hive enclosure is automatically moved from the first location to the second location when a frequency of the undesirable insects detected by the insect detector is greater than an insect threshold level.

As discussed above, the hive enclosure may be moved to habitats where there is plentiful food, or that has other desirable characteristics. The hive enclosure can be moved as part of a commercial pollination service. For example, the hive enclosure can be moved around a large field as flowers in one area of the field are pollinated. Similarly, the hive enclosure can be moved to other regions via a self-driving car or an aircraft drone based on data that enables the flowering time of various plants to be forecast.

The hive enclosure may be automatically triggered to move at a convenient time, such as at night when it is cool and bees are calm. The selection of a useful time can be improved using weather dependent population models. For example, wax moths are more active during the evenings when temps are cooler.

Relocation of the hive enclosure may be optimized in terms of providing a water supply (or being near water), supply heat, supplying a windbreak, locating close to an apiary so that they can be observe regularly, locating them near clean areas of nectar. Further contextual parameters, such as weather and proximity of cold generators (i.e., cold weather and wind), may be used to optimize the location of the hive enclosure to ensure optimal conditions for the beehive. The system may map or monitor the accessible microclimates for the hives to determine an improved microclimate/micro-habitat for the hive.

After moving step 212, the method proceeds to transmitting step 214. At transmitting step 214, hive metrics are transmitted to a beekeeper computer, such as a smart phone, laptop computer or desktop computer. The hive metrics can include a geographical location of the hive enclosure, weather conditions at the hive enclosure, a frequency of the undesirable insects detected by the insect detector, and a honey production rate at the hive enclosure. The nature and number of bees or related insect entering the enclosure may be estimated and transmitted. Individual bees, or the behavior of the hive as a whole (e.g., response to disturbances) may be monitored to detect the presence of Africanized bees. Such activity can be reported to the bee keeper computer.

As discussed above, sensors can help determine if the hive is getting overcrowded, whether the queen is laying, and even whether the hive has been stolen. The system can relay information to the beekeeper's computer. The hive enclosure may include a weighing scale, a temperature probe, a hive monitor, an entry gate that counts bees as they come and go, and a central communications hub. The monitored information from the system is accessible from the beekeeper's computer.

Machine learning algorithms may describe the beehives in terms of a status of the hive (healthy, producing honey, hibernating, poorly ventilated, unwell/diminished population, or dead). A Kalman filter may optionally use a series of measurements observed over the time, about the vehicles and bees, containing statistical noise and other inaccuracies. A Kalman filter can be employed for guidance, navigation and control of autonomous vehicles.

The hive enclosure may be used for uniting colonies. For example, the system may bring two or more beehives into close proximity and then a single sheet of newspaper is placed between them. The system punches a few small slits in the paper to make it easier for the bees to remove the paper. The bees should remove the paper with little fighting as the colonies are united.

Hives are often stolen (a problem as the diminishing bee population makes hives more valuable). In one embodiment of the present invention, the autonomous vehicle can take evasive action when theft of the hive is attempted.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A system for moving a beehive, the system comprising:
a hive enclosure for housing a bee colony, the hive enclosure including a hive entrance to the hive enclosure;
an insect detector configured to identify undesirable insects attempting to access the hive enclosure;
a door configured to exclude the undesirable insects detected by the insect detector from passing through the hive entrance; and
an autonomous vehicle coupled to the hive enclosure and configured to automatically move the hive enclosure from a first location to a second location;
wherein the hive enclosure includes an interface for attaching the hive enclosure to the autonomous vehicle and an alignment sensor to align the autonomous vehicle with the interface.

2. The system of claim 1, wherein the insect detector uses artificial neural networks (ANNs) and a support vector machine (SVM) to identify the undesirable insects.

3. The system of claim 2, wherein the insect detector uses time of year and weather conditions to identify the undesirable insects.

4. The system of claim 1, further comprising a bee attractant for attracting bees into the hive enclosure.

5. The system of claim 1, further comprising:
a pesticide detector configured to detect a pesticide concentration level at the first location; and
wherein the autonomous vehicle is configured to automatically move the hive enclosure from the first location to the second location when the pesticide concentration level is greater than a pesticide threshold level.

6. The system of claim 1, wherein the autonomous vehicle is an unmanned aerial vehicle.

7. The system of claim 1, wherein the autonomous vehicle is a self-driving car.

8. The system of claim 1, wherein the autonomous vehicle is configured to automatically move the hive enclosure from the first location to the second location when a number of the undesirable insects detected by the insect detector is greater than an insect threshold level without regard to a detected pesticide concentration level.

9. A method for moving a beehive, the method comprising:
identifying undesirable insects attempting to access a hive enclosure by an insect detector;
excluding the undesirable insects detected by the insect detector from passing through a hive entrance to the hive enclosure; and
automatically moving the hive enclosure from a first location to a second location by an autonomous vehicle coupled to the hive enclosure, the autonomous vehicle is configured to automatically move the hive enclosure from the first location to the second location when a number of the undesirable insects detected by the insect detector is greater than an insect threshold level without regard to a detected pesticide concentration level.

10. The method of claim 9, wherein identifying the undesirable insects includes using artificial neural networks (ANNs) and a support vector machine (SVM) to identify the undesirable insects.

11. The method of claim 10, wherein identifying the undesirable insects includes using time of year and weather conditions to identify the undesirable insects.

12. The method of claim 10, further comprising receiving a beehive colony in the hive enclosure.

13. The method of claim 10, further comprising placing a bee attractant for attracting bees into the hive enclosure.

14. The method of claim 10, further comprising:
detecting a pesticide concentration level at the first location; and
automatically moving the hive enclosure from the first location to the second location when the pesticide concentration level is greater than a pesticide threshold level.

15. (canceled)

16. The method of claim 10, further comprising transmitting to a beekeeper computer hive metrics, the hive metrics including a geographical location of the hive enclosure, weather conditions at the hive enclosure, a frequency of the undesirable insects detected by the insect detector, and a honey production rate at the hive enclosure.

17. A computer program product for moving a beehive, the computer program product comprising:
a non-transitory computer readable storage medium having computer readable program code embodied therewith, the computer readable program code configured to:
identify undesirable insects attempting to access a hive enclosure by an insect detector;
exclude the undesirable insects detected by the insect detector from passing through a hive entrance to the hive enclosure; and
automatically move the hive enclosure from a first location to a second location by an autonomous vehicle coupled to the hive enclosure, the autonomous vehicle is configured to automatically move the hive enclosure from the first location to the second location when a number of the undesirable insects detected by the insect detector is greater than an insect threshold level without regard to a detected pesticide concentration level.

18. The computer program product of claim 17, wherein the computer readable program code to identify the undesirable insects utilizes artificial neural networks (ANNs) and a support vector machine (SVM) to identify the undesirable insects.

19. The computer program product of claim 18, wherein the computer readable program code to identify the undesirable insects utilizes time of year and weather conditions to identify the undesirable insects.
